(19) United States
(12) Patent Application Publication
(10) Pub. No.: US 2024/0333586 A1
(43) Pub. Date: Oct. 3, 2024

(54) CONTROLLER AND METHOD FOR COUPLING DEVICES IN MESH NETWORK TO SERVER

(71) Applicant: MediaTek Singapore Pte. Ltd., Singapore (SG)

(72) Inventors: Amit Shakya, Noida (IN); Prakhar Vig, Noida (IN); Dipanshu Kumar Mittal, Noida (IN)

(73) Assignee: MediaTek Singapore Pte. Ltd., Singapore (SG)

(21) Appl. No.: 18/619,185

(22) Filed: Mar. 28, 2024

(30) Foreign Application Priority Data
Mar. 28, 2023 (IN) 202321022673

(51) Int. Cl. H04L 41/0806; H04W 72/0453

(52) U.S. Cl. CPC H04L 41/0806; H04W 72/0453

(57) ABSTRACT

A controller in a network includes a server and at least a first agent and a second agent, wherein the controller is arranged to, upon an initial boot up of all devices, determine if the first agent and the second agent are onboarding, when it is determined the first agent and the second agent are onboarding, the controller is arranged to wait to receive respective status messages from the first agent and the second agent, consolidate information in the received status messages into a single query, and send the single query to the server.

### BACKGROUND

A mesh network is a network comprising multiple Access Points (APs), wherein each AP may be an AP multi-link device (MLD) or a non-MLD AP, and the APs are coupled to an Automated Frequency Co-ordination (AFC) server via a controller. All devices operate on a same channel within the network. The AFC server maintains a list of allowed channels for all APs within the mesh network, wherein this list will be maintained by a regulator, and is provided to the APs via the controller.

The 6 GHz network is a newly defined spectrum, wherein the allowed list of channels therein is only maintained for a limited time and is according to location based allowances. In order to operate within the 6 GHz network, all APs within the mesh network will need to request the allowed list of channels from the AFC server.

The controller configures all devices within the network. APs will join the mesh network via backhaul to the controller, and comprises a Wi-Fi or Ethernet connection followed by configuration for the AP performed by the controller. This process is known as onboarding. Refer to FIG. 1 which is a diagram of configuration of devices within a mesh network according to the related art. FIG. 1 illustrates a mesh network 100 comprising an AFC server 110, a controller 130, and two APs 115 and 125. As shown in the diagram, the controller 130 can directly communicate with the AFC server 110, the APs 115, 125 use backhaul to communicate with the controller 130, and the controller 130 enable AP communication with the AFC server 110.

As all requests from the APs are made via the controller 130, there will be many requests being sent between the controller 130 and the AFC server 110 during boot up and installation. All APs must first connect to the controller 130 before the requests can be made to the AFC server 110. If an AP reboots, the AP must send another query to the AFC server 110 to find out the allowed channel list, even when a geo location of the AP has not changed, and even if a session of the AFC server 110 has not ended (i.e. the allowed channel list has not changed).

Moreover, when the current AFC server session ends, the AFC server 110 must refresh and determine a new list of allowed channels, wherein multiple requests will again be generated from all APs within the mesh network 100. During the AFC refresh, the 6 GHz channel cannot be used for communication which means the entire network operate on a lower frequency channel (e.g. 5 GHZ), and then reconnect on 6 GHz via network management. This will impact the running traffic.

There is therefore a need in the art to provide a 6 GHz mesh network wherein the number of requests made to the AFC server can be limited, and wherein a running traffic time can be improved.

### SUMMARY

A controller in a network according to an exemplary embodiment comprises a server and at least a first agent and a second agent, wherein the controller is arranged to, upon an initial boot up of all devices, determine if the first agent and the second agent are onboarding, when it is determined the first agent and the second agent are onboarding, the controller is arranged to wait to receive respective status messages from the first agent and the second agent, consolidate information in the received status messages into a single query, and send the single query to the server.

A method for coupling devices in a network to a server according to an exemplary embodiment is disclosed. The network comprises a controller and at least a first agent and a second agent. The method comprises: upon an initial boot up of all devices, determining by the controller if the first agent and the second agent are onboarding; when it is determined the first agent and the second agent are onboarding, waiting to receive respective status messages from the first agent and the second agent; consolidating information in the received status messages into a single query; and sending the single query to the server.

The determination is performed within a stabilization time of the mesh network. The status messages from the first agent and second agent comprise respective geo locations and channel groups of the first agent and second agent. The controller receives a single response from the server in response to the single query, the single response comprising an allowed list of channels for the first agent and the second agent according to their respective geo locations and channel groups.

The controller further determines a best channel for both the first agent and the second agent according to the single response from the server; and generates respective channel selection requests to the first agent and the second agent, the channel selection request indicating the best channel and a common allowed channel list. When the single response indicates that at least one of the first agent and the second agent is not allowed to operate on the 6 GHz frequency, the controller sends a tear down message to the corresponding agent for informing the agent to switch to a different frequency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mesh network according to the related art.

FIG. 2 is a diagram of communication between devices in a mesh network upon initial boot up according to an exemplary embodiment of the present invention.

FIG. 3 is a diagram of communication between devices in a mesh network when an access point reboots according to an exemplary embodiment of the present invention.

FIG. 4 is a diagram of communication between devices in a mesh network when a server refreshes according to an exemplary embodiment of the present invention.

### DETAILED DESCRIPTION

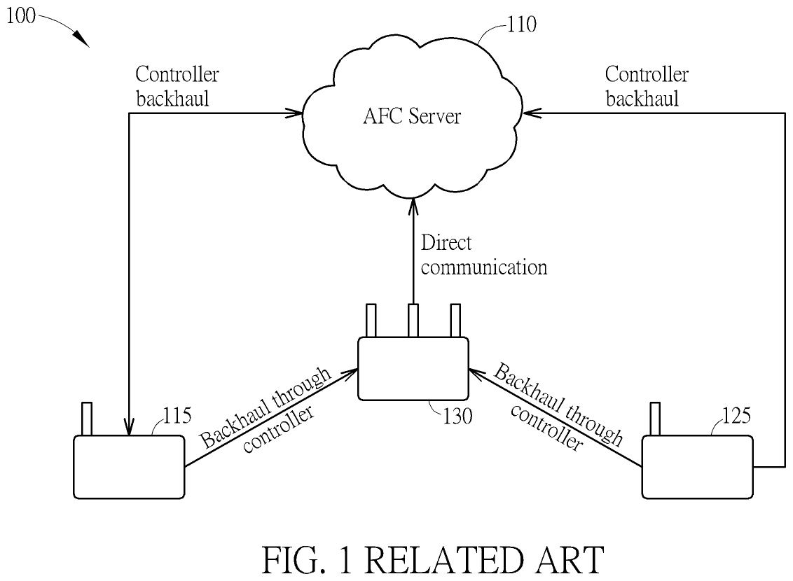

The present invention provides a controller and a method for operating the same, wherein the controller operates within a mesh network (e.g., 6 GHz network) and can limit the communication between the controller and an AFC server within the mesh network to improve running traffic. The controller may be operated within 6 GHz or any other operable frequency. In the following, the description can refer to the devices illustrated in FIG. 1.

After APs within the mesh network have onboarded, the controller will know the geo locations, operating class and channel groups of the respective APs. In the related art, the controller will send a query to the AFC server as soon as each AP is onboarded, wherein the query contains information regarding the AP. In the present invention, however, the controller waits until all APs within the network have completed their onboarding process, and then consolidate all information of the onboarded APs into a single query which will be sent to the AFC server. The controller can wait for a network stabilization time of the mesh network to determine a number of APs within the network, and therefore can know how many requests will be received.

The AFC server can reply to the single query with a single response, wherein an allowed list of channels for all APs is included within the single response. The controller 130 can then determine a best channel for all the APs and send channel selection requests to all the APs within the mesh network to indicate a common list of channels as determined by the AFC server 110 and a best/preferred channel within said list. Additionally, if it is determined that at least one of the APs within the mesh network is not allowed to use a predetermined frequency, such as 6 GHz, then the controller 130 will send a tear down message to said AP.

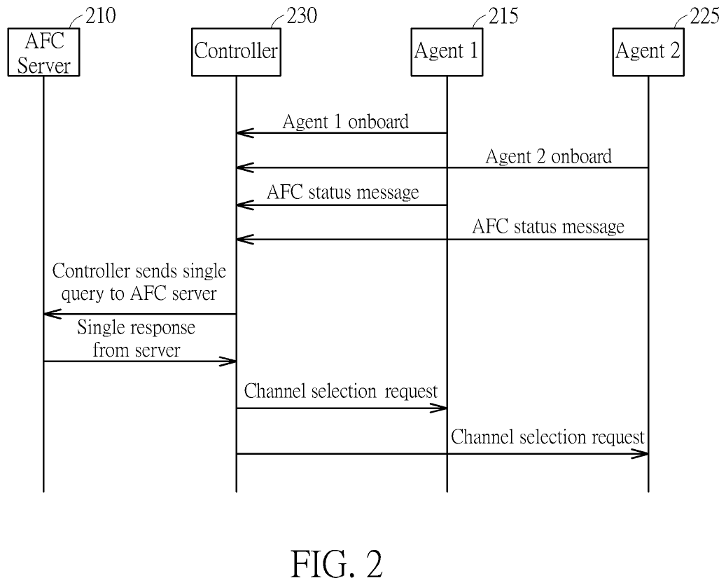

The above method is illustrated in FIG. 2. As shown in the diagram, each AP sends an onboarding message followed by an AFC status message to the controller. The controller waits until AFC status messages from all onboarded APs are received, then consolidates the geo location and channel lists of all the APs into a single request which is sent to the AFC server. In response, the AFC server replies with a single response indicating an allowed list of channels. The controller finds a common list of channels for the APs and also marks a preferred channel therein, and sends this information to each AP as a channel selection request.

The above method significantly reduces the traffic within the mesh network 100 which means configuration of the entire network can be performed much faster than in the related art.

As detailed in the background, when an AP within the network reboots, the AP sends a message to the controller 130 indicating that its status is unresolved (i.e. the AP cannot determine if its geo location and allowed channel session is allowed by the AFC server or if a new list of channels must be requested. In the prior art, the controller would send a query to the AFC server; however, as the controller knows both the geo location and operating time of the AP and the operating time of the AFC server and the allowed list of channels, if the AP's geo location is the same and the AFC server session has not reached timeout, the controller can directly provide the AP with the same channel selection request as illustrated in FIG. 2.

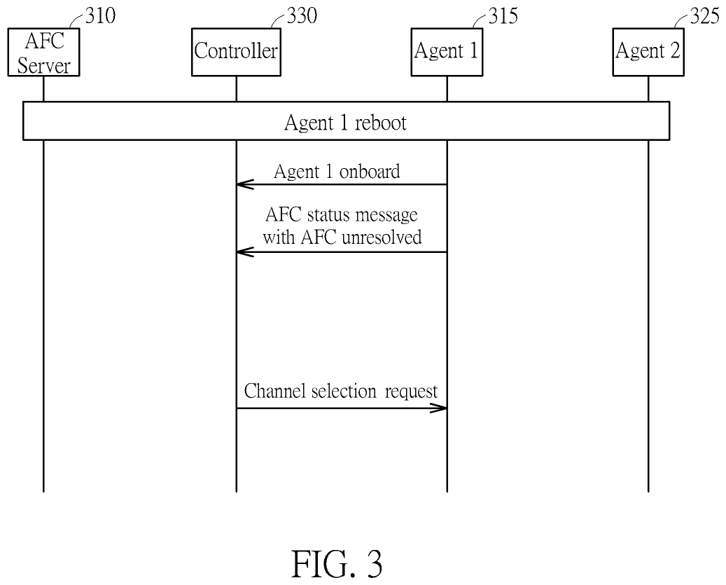

Refer to FIG. 3, which is a diagram of the above method. As shown in the diagram, the AP 115 is onboarded and then sends a status message indicating the status is unresolved. In response, the controller checks the geo location therein with its own database. When the geo location is the same, the controller then checks whether an AFC session has reached timeout. If the AFC session has not reached timeout, the information in the previous channel selection request is still valid and the controller therefore directly sends the channel selection request to the AP 115 without needing to send a query to the AFC server 110.

When the AFC server session reaches timeout, the 6 GHz channel will be blocked. The controller therefore sends a backhaul steer command to all the APs for instructing them to operate on the 5 GHZ channel. The controller can also request an updated list of allowed channels from the AFC server 110 before the session reaches timeout by requesting geo locations from all APs before the session reaches timeout. In this way, the APs within the mesh network 100 can be updated without needing to restart all interfaces. For example, when the current session reaches 80% of its allowed time, the controller 130 can determine to send requests to the APs for determining their geo locations, combine all requests into a single query to be sent to the AFC server 110, send an updated common channel to the APs, and determine a best channel to be used on the 6 GHz network.

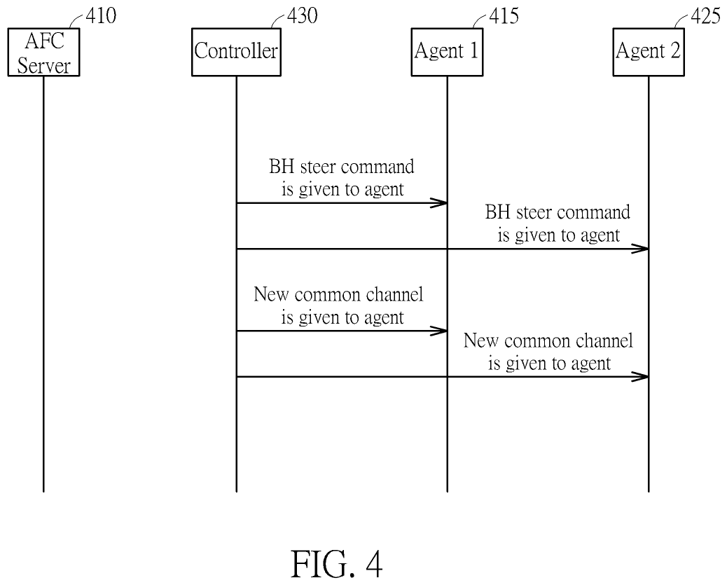

Refer to FIG. 4, which illustrates the above method. As shown in the diagram, the controller sends a backhaul steer command to the APs instructing the APs to switch to the 5 GHz operating channel without the APs needing to disconnect from the network and start scanning for backhaul commands. The controller will then send a common channel on the 5 GHz frequency, and then this common channel can be used by the APs and the controller 130 to perform the method illustrated in FIG. 2.

The device and method of the present invention enables the number of messages generated to an AFC server within a mesh network (e.g., 6 GHz network) to be significantly reduced, which optimizes the running traffic within the network. In addition, the boot up time can be optimized, and channel planning when an AFC server refresh occurs can also be more efficient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller in a network comprising a server and at least a first agent and a second agent, wherein the controller is arranged to, upon an initial boot up of all devices, determine if the first agent and the second agent are onboarding, when it is determined the first agent and the second agent are onboarding, the controller is arranged to wait to receive respective status messages from the first agent and the second agent, consolidate information in the received status messages into a single query, and send the single query to the server.

2. The controller of claim 1, wherein the status messages from the first agent and second agent comprise respective geo locations and channel groups of the first agent and second agent.

3. The controller of claim 2, wherein the controller is further arranged to receive a single response from the server in response to the single query, the single response comprising an allowed list of channels for the first agent and the second agent according to their respective geo locations and channel groups.

4. The controller of claim 3, wherein the controller is further arranged to determine a best channel for both the first agent and the second agent according to the single response from the server, and generate respective channel selection requests to the first agent and the second agent, the channel selection request indicating the best channel and a common allowed channel list.

5. The controller of claim 3, wherein when the single response indicates that at least one of the first agent and the second agent is not allowed to operate on 6 GHz frequency, the controller is arranged to send a tear down message to the corresponding agent for informing the agent to switch to a different frequency.

6. The controller of claim 1, wherein the controller performs the determination within a stabilization time of the mesh network.

7. The controller of claim 4, wherein when at least one of the first agent and second agent reboots, the controller is arranged to receive an updated message from status the agent, determine/compare a geo location of the agent according to the updated status message with a previous geo location of the agent according to the status message, and when the geo location has not changed and a remaining time for the allowed channel list has not reached a timeout, the controller is arranged to directly send the previous channel selection request without sending a query to the server.

8. The controller of claim 4, wherein when the controller determines a remaining time for the allowed channel list is about to reach timeout, the controller sends an updated single query to the server comprising updated respective geo locations of the first agent and the second agent.

9. The controller of claim 8, wherein the controller is arranged to receive an updated single response from the server in response to the updated single query, the updated single response comprising an allowed channel list according to the updated respective geo locations, and when timeout is reached, the server refreshes, and the controller is arranged to send an update message to any of the first agent and the second agent when the updated single response indicates a change in their allowed channel list.

10. The controller of claim 9, wherein when the server refresh occurs, when a current respective operating channel of the first agent and the second agent is blocked, the controller sends a respective backhaul steer command to the first agent and the second agent for instructing the first agent and the second agent to switch to a different operating frequency, and the controller selects a new common channel and updates the first agent and the second agent with the new common channel.

11. A method for coupling devices in a network to a server, the network comprising a controller and at least a first agent and a second agent, the method comprising:
upon an initial boot up of all devices, determining by the controller if the first agent and the second agent are onboarding;
when it is determined the first agent and the second agent are onboarding, waiting to receive respective status messages from the first agent and the second agent;
consolidating information in the received status messages into a single query; and
sending the single query to the server.

12. The method of claim 11, wherein the status messages from the first agent and second agent comprise respective geo locations and channel groups of the first agent and second agent.

13. The method of claim 12, further comprising:
receiving a single response from the server in response to the single query, the single response comprising an allowed list of channels for the first agent and the second agent according to their respective geo locations and channel groups.

14. The method of claim 13, further comprising:
determining a best channel for both the first agent and the second agent according to the single response from the server; and
generating respective channel selection requests to the first agent and the second agent, the channel selection request indicating the best channel and a common allowed channel list.

15. The method of claim 13, wherein when the single response indicates that at least one of the first agent and the second agent is not allowed to operate on 6 GHz frequency, the method further comprises:
sending a tear down message to the corresponding agent for informing the agent to switch to a different frequency.

16. The method of claim 11, wherein the determination is performed within a stabilization time of the mesh network.

17. The method of claim 4, further comprising:
when at least one of the first agent and second agent reboots, receiving an updated status message from the agent;
determining/comparing a geo location of the agent according to the updated status message with a previous geo location of the agent according to the status message; and
when the geo location has not changed and a remaining time for the allowed channel list has not reached a timeout, directly sending the previous channel selection request without sending a query to the server.

18. The method of claim 14, wherein when a remaining time for the allowed channel list is about to reach timeout, the method further comprises:
sending an updated single query to the server comprising updated respective geo locations of the first agent and the second agent.

19. The method of claim 18, further comprising:
receiving an updated single response from the server in response to the updated single query, the updated single response comprising an allowed channel list according to the updated respective geo locations; and
when timeout is reached and the server refreshes, sending an update message to any of the first agent and the second agent when the updated single response indicates a change in their allowed channel list.

20. The method of claim 19, wherein when the server refresh occurs, and a current respective operating channel of the first agent and the second agent is blocked, the method further comprises:
sending a respective backhaul steer command to the first agent and the second agent for instructing the first agent and the second agent to switch to a different operating frequency;
selecting a new common channel; and
updating the first agent and the second agent with the new common channel.
